(19) United States
(12) Patent Application Publication
(10) Pub. No.: US 2011/0061848 A1
(43) Pub. Date: Mar. 17, 2011

(54) Heat Dissipation Module and the Manufacturing Method Thereof

(75) Inventors: Yau-Hung Chiou, Taipei (TW); Shu-Hui Fan, Hsinchu County (TW); Yuan-Li Chuang, Taipei County (TW)

(73) Assignee: CHENMING MOLD IND. CORP., Taipei City (TW)

(21) Appl. No.: 12/874,473

(22) Filed: Sep. 2, 2010

(30) Foreign Application Priority Data
Sep. 16, 2009 (TW) 098131299

(51) Int. Cl. F28F 7/00; B23P 15/26

(52) U.S. Cl. 165/185; 29/890.054

(57) ABSTRACT

The present invention discloses a heat dissipation module and a manufacturing method thereof. The heat dissipation module comprises a metal base, a porous metal layer and a metal plate member. The porous metal layer is disposed on one side of the metal base and includes a plurality of micropores. Parts of the plurality of micropores contain a metal medium. The metal plate member is disposed on one side of the porous metal layer. Heat is rapidly conducted from the metal base through the metal plate member to the environment by means of the porous metal layer and the metal medium.

### BACKGROUND OF THE INVENTION

1. Field of the Invention

The present invention relates to a heat dissipation module and a manufacturing method thereof, and more particularly to a heat dissipation module including a porous metal layer and a manufacturing method thereof.

2. Description of Related Art

As technology increasingly advances and electronic devices have continuously become popularized, people often use electronic devices in everyday life to help deal with work, enjoy multimedia entertainment or expand personal relationships. However, with increased computing power available through electronic devices, excessive heat will be generated and accumulated during their operations, resulting in overheating to reduce the service efficiency or operating life of the electron devices. One of common and effective ways to solve overheating problems for electronic devices is the installation of heat dissipation modules on overheated components in an electronic device, so as to introduce heat into the environment to lower the operating temperature of the components.

A conventional heat dissipation module comprises a heat sink portion and a plurality of heat dissipation fins. The heat sink portion can be attached to components to carry off the heat generated by the components in the direction toward the heat dissipation module. The heat dissipation fins can increase the heat dissipation area of the heat dissipation module for dissipating heat to the environment, so the heat dissipation efficiency can be increased by changing the number and shape of the heat dissipation fins. However, the production difficulty, time and costs must be significantly increased when the heat dissipation fins and the heat sink of different shapes are manufactured in the same mold.

Currently, in the production of heat dissipation modules, direct welding at high temperature cannot be used due to restrictions on the shape of heat dissipation fins or the difference between physical properties of different metal materials. Nickel layers must be electroplated on the surfaces of the heat dissipation fins or the heat sink or both of them, and then a low melting point metal is selected to solder both of them together. However, all of the metals in the nickel layers and the low melting point metal are metals having a low thermal conductivity coefficient and thus increase the overall effective thermal resistance after bonding, that is, reduce the overall heat dissipation efficiency. Moreover, when an electroplating method is used, it is necessary to use a large number of acidic chemicals. After electroplating, the plating bath contains acidic heavy metals. It is not only very highly toxic but also difficult to be recycled, as well as not environmentally friendly. If a local electroplating method is used, it also needs to take more time and cost more. As a result, there is a need to change the bonding method to reduce the overall effective thermal resistance and production difficulty.

### SUMMARY OF THE INVENTION

In view of the above-mentioned problems of the prior art, an object of the present invention is to provide a heat dissipation module and a manufacturing method thereof, which solve the problem caused by an increased thermal resistance between connected metals.

According to an object of the present invention, there is provided a heat dissipation module comprising a metal base, a porous metal layer and a metal plate member. The porous metal layer includes a plurality of micropores and is disposed on one side of the metal base. A metal medium is filled into the plurality of micropores.

Wherein, the metal base or the metal plate member is comprised of a metal or alloy having a thermal conductivity coefficient greater than 200 W/mK.

Wherein, the metal or alloy having a thermal conductivity coefficient greater than 200 W/mK is preferably gold, silver, copper, aluminum or an alloy thereof.

Wherein, the thickness of the porous metal layer ranges from 1 μm to 1000 μm.

Wherein, the porosity of the porous metal layer ranges from 2% to 50%.

Wherein, the thermal conductivity coefficient of the porous metal layer is greater than 100 W/mK.

Wherein, the metal medium is comprised of gallium, indium, bismuth, tin, zinc or an alloy thereof.

Wherein, the metal base is a heat sink.

Wherein, the metal plate member comprises a plurality of heat dissipation fins.

According to an object of the present invention, there is further provided a manufacturing method of a heat dissipation module, which comprises the following steps. First, a porous metal layer is coupled to one side of a metal base using a metal bonding method. Second, a metal plate member is coupled to the other side of the porous metal layer using a metal bonding method. Finally, a metal medium is filled into the porous metal layer to fill up parts of the plurality of micropores.

Wherein, the metal bonding method includes the process of sintering, welding or sandblasting.

Wherein, the method for filling the metal medium includes the process of vacuum filling or gravity filling.

Wherein, the porous metal layer includes a plurality of open pores and a plurality of closed pores.

Wherein, the metal medium is filled into the plurality of open pores.

As described above, the heat dissipation module of the present invention may have one or more of the following advantages:

(1) The porous metal layer having a thermal conductivity coefficient not less than 100 W/mK is disposed between the metal base and the metal plate member, so as to avoid significant reduction in the overall heat dissipation efficiency of the heat dissipation module.

(2) The manufacturing method of a heat dissipation module has no need to use an electroplating method, so as to avoid pollution caused by the use of acidic chemicals in electroplating and provide an environmentally friendly manufacturing process.

### BRIEF DESCRIPTION OF THE DRAWINGS

FIG. 1 is a schematic view of a heat dissipation module according to one embodiment of the present invention; and

FIG. 2 is a flow chart showing the steps of a manufacturing method of a heat dissipation module according to the present invention.

### DETAILED DESCRIPTION OF THE PREFERRED EMBODIMENTS

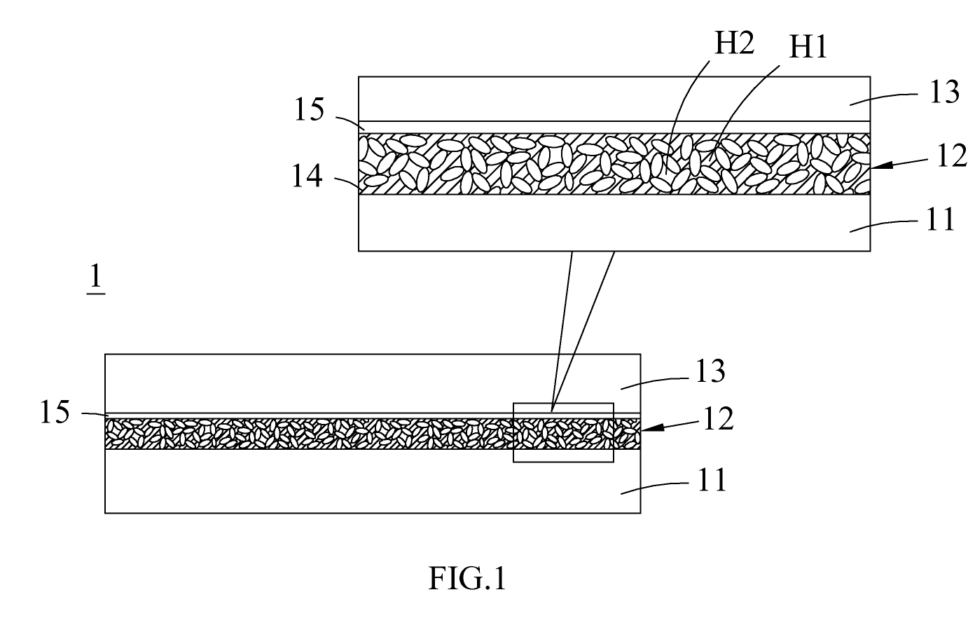

Referring to FIG. 1, FIG. 1 is a schematic view of a heat dissipation module according to one embodiment of the present invention. In FIG. 1, a heat dissipation module 1 comprises a metal base 11, a porous metal layer 12 and a metal plate member 13.

The porous metal layer 12 is disposed on one side of the metal base 11, and the metal plate member 13 is on one side of the porous metal layer 12. The metal base 11 and the metal plate member 13 each may be comprised of a metal or alloy having a thermal conductivity coefficient greater than 200 W/mK. Preferably, the metal or alloy is gold, silver, copper, aluminum or an alloy thereof. The metal base 11 and the metal plate member 13 can be processed by stamping or mold casting to form desired shapes.

The porous metal layer 12 constituted by metal powders whose particle diameters are uniform is coupled to the metal base 11 or the metal plate member 13, and includes a plurality of open pores H1 and a plurality of closed pores H2. The porous metal layer 12 can be formed with a thickness of from about 1 μm to about 1000 μm as required. The porosity can be adjusted between 2% and 50%. In order to avoid the excessively great thermal resistance effect caused by the air in the voids, a metal medium 14 is filled into the porous metal layer 12, the metal medium 14 can be filled into the open pores H1 but cannot be filled into the closed pores H2. The metal medium 14 is a low melting point metal, which may be comprised of gallium, indium, bismuth, tin, zinc or an alloy thereof, but the present invention is not limited thereto. Additionally, the thermal conductivity coefficient of the porous metal layer is greater than 100 W/mK, so as to avoid the drawback of the prior art that the effective heat dissipation efficiency of the entire heat dissipation module is significantly reduced after the metal base is bonded to the metal plate member by means of nickel layers and a low melting point metal because the metals in the nickel layers and the low melting point metal are metals having a low thermal conductivity coefficient.

In the present invention, a heat conduction metal layer 15 is further provided between the metal base 11 and the porous metal layer 12 or between the metal plate member 13 and the porous metal layer 12 by a metal bonding method of heat fusion to connect the metal base 11 and the porous metal layer 12 or connect the metal plate member 13 and the porous metal layer 12.

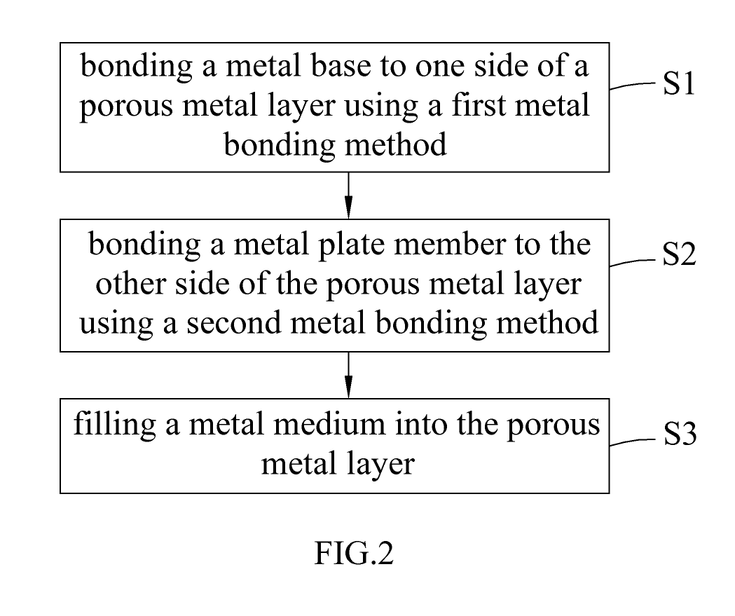

Referring to FIG. 2, there is shown a flow chart showing the steps of a manufacturing method of a heat dissipation module according to the present invention. In this embodiment, the manufacturing method of a heat dissipation module comprises the following steps:

S1: bonding a metal base to one side of a porous metal layer using a first metal bonding method;

S2: bonding a metal plate member to the other side of the porous metal layer using a second metal bonding method;

S3: filling a metal medium into the porous metal layer.

FIGS. 1 and 2 are simultaneously referred to for the following discussion. First, the metal base and the metal plate member can be processed by stamping or mold casting to form desired shapes. The metal base may be a heat sink in physical contact with electronic components from which heat is to be dissipated. The metal plate member may be a heat dissipation fin to conduct the heat generated by the electronic components through the heat sink and the heat dissipation fin to the environment.

In the present invention, the first metal bonding method or the second metal bonding method comprises applying metal powders to the surfaces of the metal base and the metal plate member by sintering, welding or sandblasting of the metal base and the metal plate member to form the porous metal layer. Furthermore, the first metal bonding method or the second metal bonding method comprises forming a heat conduction metal layer on the surface of the porous metal layer by thermal spraying to connect the metal base, the porous metal layer and the metal plate member. In other words, if the porous metal layer is formed on the metal base using the first metal bonding method, thermal spraying is applied to the surface of the porous metal layer using the second metal bonding method to form a heat conduction metal layer for the connection with the metal plate member. On the contrary, if the porous metal layer is formed on the metal plate member using the second metal bonding method, thermal spraying is applied to the surface of the porous metal layer using the first metal bonding method to form a heat conduction metal layer for the connection with the metal base.

Finally, a metal medium is filled into the porous metal layer by the process of vacuum filling or gravity filling. The porous metal layer includes a plurality of open pores and a plurality of closed pores. Also referring to the enlarged view of FIG. 1, it can be seen that the metal medium cannot be filled into the closed pores so the metal medium is present only in the open pores.

In summarization of the foregoing description, a feature of the heat dissipation module according to the present invention is that the metal base is connected with the metal plate member via the porous metal layer having a thermal conductivity coefficient greater than 100 W/mK so the heat dissipation module has a higher overall heat transfer efficiency than that of a conventional heat dissipation module fabricated by electroplating.

Another feature is that the plate member according to the present invention does not require electroplating so the acidic chemicals which cause pollution to the environment will not be generated.

The above description is illustrative only and is not to be considered limiting. Various modifications or changes can be made without departing from the spirit and scope of the invention. All such equivalent modifications and changes shall be included within the scope of the appended claims.

What is claimed is:

1. A heat dissipation module comprising:
a metal base;
a porous metal layer disposed on one side of the metal base, the porous metal layer including a plurality of micropores, parts of the plurality of micropores containing a metal medium; and
a metal plate member disposed on one side of the porous metal layer.

2. The heat dissipation module as claimed in claim 1, wherein the metal base or the metal plate member is comprised of a metal or alloy having a thermal conductivity coefficient greater than 200 W/mK.

3. The heat dissipation module as claimed in claim 2, wherein the metal or alloy having a thermal conductivity coefficient greater than 200 W/mK is gold, silver, copper, aluminum or an alloy thereof.

4. The heat dissipation module as claimed in claim 1, wherein thickness of the porous metal layer ranges from 1 μm to 1000 μm.

5. The heat dissipation module as claimed in claim 4, wherein porosity of the porous metal layer ranges from 2% to 50%.

6. The heat dissipation module as claimed in claim 5, wherein thermal conductivity coefficient of the porous metal layer is greater than 100 W/mK.

7. The heat dissipation module as claimed in claim 1, wherein the metal medium is comprised of gallium, indium, bismuth, tin, zinc or an alloy thereof.

8. The heat dissipation module as claimed in claim 1, wherein the metal base is a heat sink.

9. The heat dissipation module as claimed in claim 1, wherein the metal plate member is a heat dissipation fin.

10. The heat dissipation module as claimed in claim 1, further comprising a heat conduction metal layer provided between the metal base and the porous metal layer by thermal spraying, and wherein the heat conduction metal layer connects the metal base and the porous metal layer.

11. The heat dissipation module as claimed in claim 1, further comprising a heat conduction metal layer provided between the metal plate member and the porous metal layer by thermal spraying, and wherein the heat conduction metal layer connects the metal plate member and the porous metal layer.

12. A manufacturing method of a heat dissipation module, comprising the following steps:
bonding a metal base to one side of a porous metal layer using a first metal bonding method;
bonding a metal plate member to the other side of the porous metal layer using a second metal bonding method; and
filling a metal medium into the porous metal layer.

13. The manufacturing method of a heat dissipation module as claimed in claim 12, wherein the metal base or the metal plate member is comprised of a metal or alloy having a thermal conductivity coefficient greater than 200 W/mK.

14. The manufacturing method of a heat dissipation module as claimed in claim 13, wherein the metal or alloy having a thermal conductivity coefficient greater than 200 W/mK is gold, silver, copper, aluminum or an alloy thereof.

15. The manufacturing method of a heat dissipation module as claimed in claim 12, wherein thickness of the porous metal layer ranges from 1 μm to 1000 μm.

16. The manufacturing method of a heat dissipation module as claimed in claim 15, wherein porosity of the porous metal layer ranges from 2% to 50%.

17. The manufacturing method of a heat dissipation module as claimed in claim 16, wherein thermal conductivity coefficient of the porous metal layer is greater than 100 W/mK.

18. The manufacturing method of a heat dissipation module as claimed in claim 12, wherein the first metal bonding method or the second metal bonding method comprises applying metal powders to the surfaces of the metal base and the metal plate member by one of sintering, welding and sandblasting of the metal base and the metal plate member to form the porous metal layer.

19. The manufacturing method of a heat dissipation module as claimed in claim 12, wherein the first metal bonding method comprises forming a heat conduction metal layer on the surface of the porous metal layer by thermal spraying to connect the metal base and the porous metal layer.

20. The manufacturing method of a heat dissipation module as claimed in claim 12, wherein the second metal bonding method comprises forming a heat conduction metal layer on the surface of the porous metal layer by thermal spraying to connect the metal plate member and the porous metal layer.

21. The manufacturing method of a heat dissipation module as claimed in claim 12, wherein the metal medium is comprised of gallium, indium, bismuth, tin, zinc or an alloy thereof.

22. The manufacturing method of a heat dissipation module as claimed in claim 21, wherein the method for filling the metal medium is vacuum filling or gravity filling.

23. The manufacturing method of a heat dissipation module as claimed in claim 12, wherein the porous metal layer includes a plurality of open pores and a plurality of closed pores.

24. The manufacturing method of a heat dissipation module as claimed in claim 23, wherein the metal medium is filled into the plurality of open pores.

25. The manufacturing method of a heat dissipation module as claimed in claim 12, wherein the metal base is a heat sink.

26. The manufacturing method of a heat dissipation module as claimed in claim 12, wherein the metal plate member comprises a plurality of heat dissipation fins.
